(19) United States
(12) Patent Application Publication
(10) Pub. No.: US 2005/0010913 A1
(43) Pub. Date: Jan. 13, 2005

(54) Computer code upgrading method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/618,881

(22) Filed: Jul. 11, 2003

(51) Int. Cl. G06F 9/44

(52) U.S. Cl. 717/168; 717/170; 717/172

(57) ABSTRACT

A computer code upgrading method and system is proposed, which is designed for use with a non-volatile programmable memory module, such as a network server's internal system memory module, for the purpose of upgrading the server's embedded computer code, such as embedded operating system, while allowing the newly-upgraded operating system to use all the old settings data that were previously used by the old version operating system, without requiring network system management personnel to manually input these previously-used settings data to the newly-upgraded operating system. This feature allows the network system management to be more efficient than prior art.

### BACKGROUND OF THE INVENTION

1. Field of the Invention

This invention relates to information technology, and more particularly, to a computer code upgrading method and system which is designed for use with a non-volatile programmable memory module, such as a network server's internal system memory module, for the purpose of upgrading the server's embedded computer code, such as embedded operating system, while allowing the newly-upgraded operating system to use all the old settings data that were previously used by the old version operating system, without requiring network system management personnel to manually input these previously-used settings data to the newly-upgraded operating system.

2. Description of Related Art

Embedded operating system is an operating system that is permanently programmed in a non-volatile memory module, such as a flash memory module, and is commonly integrated to an information platform, such as a network server, a PDA (Personal Digital Assistant), a mobile phone handset, and so on, to control the system operations of the information platform.

In application, a network server's embedded operating system is often required to use user-specified settings, including, for example, a list of authorized users, each user's username and password, domain settings, hard disk settings, and so on. These settings are inputted to the embedded operating system manually by the network system management personnel before the embedded operating system is put into operation.

As a newer version of server operating system is released, it is then required to upgrade the server's current embedded operating system. Traditionally, a direct-write upgrading procedure is used to replace the old version of embedded operating system in the server, whereby the first step is to erase all the code and data, including the embedded operating system and its settings data, and then the new version of server operating system is written into the emptied memory module. After this, the network system management personnel needs to manually input the previously-used settings to the newly-upgraded operating system so as to allow the newly-upgraded operating system to use the old settings.

However, since a server operating system's settings data typically include quite a large number of various items of data, such as a list of authorized users, each user's user-name and password, domain settings, hard disk settings, and so on, the traditional way of upgrading a server's embedded operating system is undoubtedly quite laborious and time-consuming and therefore is quite inefficient to network management.

### SUMMARY OF THE INVENTION

It is therefore an objective of this invention to provide a computer code upgrading method and system that allows the newly-upgraded operating system to use all the old settings data that were previously used by the old version operating system, without requiring the network system management personnel to manually input the previously-used settings to the newly-upgraded operating system.

It is another objective of this invention to provide a computer code upgrading method and system which allows a server's embedded operating system to undergo an upgrading procedure more quickly and efficiently.

The computer code upgrading method and system according to the invention is designed for use with a memory module for upgrading a set of embedded computer code and its related settings data in the memory module, such as an embedded operating system, and which is characterized by first duplicating a copy of the settings data; then erasing all the computer code and settings data in the memory module; and then writing a new version of computer code into the memory module; and finally writing the duplicated copy of settings data into the memory module. As the newly-upgraded operating system is started to operate, it can immediately use the old settings data, without requiring the network system management personnel to manually input the previously-used settings to the newly upgraded operating system. This feature allows the network system management to be more efficient than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the computer code upgrading system according to the invention; and

FIG. 2 is a flow diagram showing the operational procedures performed by the computer code upgrading method and system according to the invention.

### DETAILED DESCRIPTION OF PREFERRED EMBODIMENTS

The computer code upgrading method and system according to the invention is disclosed in full details by way of preferred embodiments in the following with reference to the accompanying drawings.

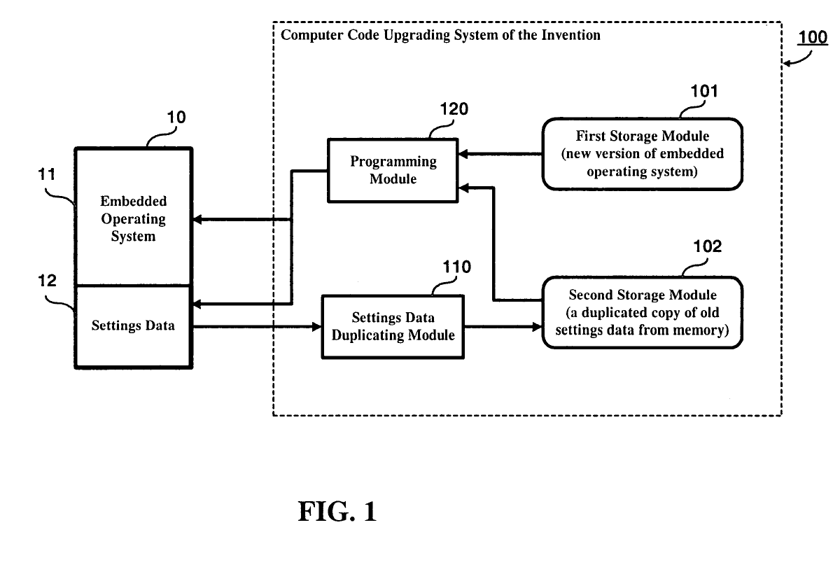

FIG. 1 is a schematic diagram showing the object-oriented component model of the computer code upgrading system (as the part enclosed in the dotted box indicated by the reference numeral 100) according to the invention. As shown, in application, the computer code upgrading system of the invention 100 is coupled to a nonvolatile programmable memory module 10, such as the internal system memory module of a network server (not shown), which is used for the embedding of a set of computer code and its settings data, such as the server's embedded operating system 11 and its settings data 12. These settings data 12 may include a list of authorized users, each user's username and password, domain settings, hard disk settings, and so on. The computer code upgrading system of the invention 100 allows the user to upgrade the embedded operating system 11 in the memory module 10 while preserving the old settings data 12 without requiring the network system management personnel to manually input old settings data to the newly-upgraded operating system.

As shown in FIG. 1, the object-oriented component model of the computer code upgrading system of the invention 100 comprises: (a) a first storage module 101; (b) a second storage module 102; (c) a settings data duplicating module 110; and (d) a programming module 120.

The first storage module 101 can be, for example, a portion of the storage space of the server's hard disk, internal system memory, or any other type of storage media, which is used to store a new version of computer code, such as a new version of operating system, which is to be used to replace the old version of embedded operating system 11 in the memory module 10.

The second storage module 102 can be, for example, a portion of the storage space of the server's RAM (random-access memory) module, hard disk, or any other type of storage media, which is used to store a duplicated copy of the old settings data 12 in the memory module 10 before all the code and data in the memory module 10 is erased in the upgrading procedure.

The settings data duplicating module 110 is capable of duplicating the old settings data 12 in the memory module 10 before all the code and data in the memory module 10 is erased in the upgrading process, and store the duplicated copy of the settings data 12 into the second storage module 102.

The programming module 120 is capable of erasing all the code and data in the memory module 10 and then writing both the new version of embedded operating system stored in the first storage module 101 and the duplicated copy of old settings data stored in the second storage module 102 into the memory module 10.

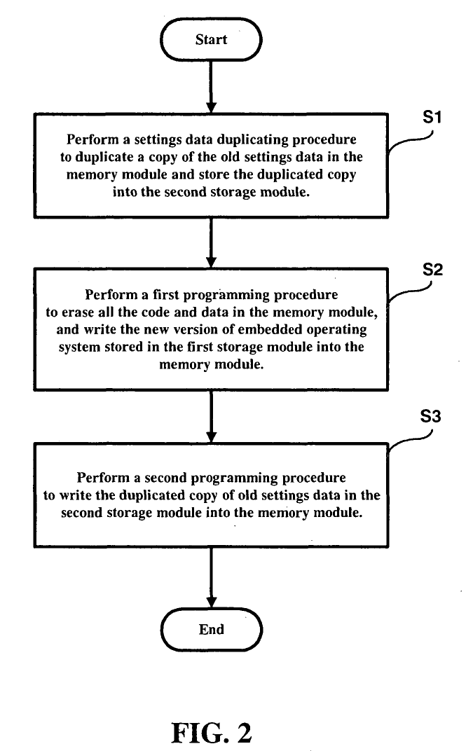

FIG. 2 is a flow diagram showing the operational procedures performed by the computer code upgrading system of the invention 100 when a new version of embedded operating system is available and to be used to upgrade the old version of embedded operating system 11 in the memory module 10.

Referring to FIG. 2 together with FIG. 1, the first step S1 is to perform a settings data duplicating procedure, wherein the settings data duplicating module 110 is activated to duplicate a copy of the old settings data 12 in the memory module 10, and then store the duplicated copy of settings data into the second storage module 102.

In the next step S2, the programming module 120 is activated to perform a first programming procedure on the memory module 10, wherein the programming module 120 first erase all the code and data in the memory module 10, including the old version of embedded operating system 11 and the old settings data 12, and then write the new version of embedded operating system stored in the first storage module 101 into the memory module 10.

In the next step S3, after the new version of operating system has been written into the memory module 10, the programming module 120 is subsequently activated to perform a second programming procedure on the memory module 10, whereby the duplicated copy of old settings data stored in the second storage module 102 is written back into the memory module 10, allowing the newly-upgraded embedded operating system 11 to use the old settings data 12. This completes the upgrading procedure by the computer code upgrading system of the invention 100.

As the newly-upgraded operating system 11 is started to operate, it can immediately use the old settings data 12, without requiring the network system management personnel to manually input the previously-used settings to the newly-upgraded operating system.

In conclusion, the invention provides a computer code upgrading method and system, which is designed for use with a memory module for upgrading a set of embedded computer code and its related settings data in the memory module, such as an embedded operating system, and which is characterized by first duplicating a copy of the settings data; then erasing all the computer code and settings data in the memory module; and then writing a new version of computer code into the memory module; and finally writing the duplicated copy of settings data into the memory module. As the newly-upgraded operating system is started to operate, it can immediately use the old settings data, without requiring the network system management personnel to manually input the previously-used settings to the newly upgraded operating system. This feature allows the network system management to be more efficient than prior art. The invention is therefore more advantageous to use than prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A computer code upgrading method for use with a memory module for upgrading a set of embedded computer code and its related settings data in the memory module;
the computer code upgrade method comprising:
duplicating a copy of the settings data;
erasing all the computer code and settings data in the memory module;
writing a new version of computer code into the memory module; and
writing the duplicated copy of settings data into the memory module.

2. The computer code upgrading method of claim 1, wherein the memory module is a server's internal erasable programmable memory module.

3. The computer code upgrading method of claim 1, wherein the computer code stored in the memory module is an embedded operating system.

4. A computer code upgrading system for use with a memory module for upgrading a set of embedded computer code and its related settings data in the memory module;
the computer code upgrade system comprising:
a first storage module for storing a new version of computer code;
a second storage module for storing a duplicated copy of the old settings data in the memory module;
a settings data duplicating module for duplicating a copy of the old settings data in the memory module and storing the duplicated copy of old settings data in the second storage module; and
a programming module, which is capable of erasing all the computer code and settings data in the memory module, and then writing the new version of computer code stored in the first storage module as well as the duplicated copy of settings data stored in the second storage module into the memory module.

5. The computer code upgrading system of claim 5, wherein the memory module is a server's internal erasable programmable memory module.

6. The computer code upgrading system of claim 5, wherein the computer code stored in the memory module is an embedded operating system.

7. The computer code upgrading system of claim 5, wherein the second storage module is a RAM module.

8. A computer code upgrading system for use with a memory module for upgrading an embedded operating system and its related settings data in the memory module;
the computer code upgrade system comprising:
a first storage module for storing a new version of embedded operating system;
a second storage module for storing a duplicated copy of the old settings data in the memory module;
a settings data duplicating module for duplicating a copy of the old settings data in the memory module and storing the duplicated copy of old settings data in the second storage module; and
a programming module, which is capable of erasing the old version of embedded operating system and settings data in the memory module, and then writing the new version of embedded operating system stored in the first storage module as well as the duplicated copy of settings data stored in the second storage module into the memory module.

9. The computer code upgrading system of claim 5, wherein the memory module is a server's internal erasable programmable memory module.

10. The computer code upgrading system of claim 5, wherein the second storage module is a RAM module.
